(19) United States
(12) Patent Application Publication
(10) Pub. No.: US 2006/0143423 A1
(43) Pub. Date: Jun. 29, 2006

(54) Storage device, data processing method thereof, data processing program thereof, and data processing system

(75) Inventor: Koutarou Sasage, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/090,286

(22) Filed: Mar. 28, 2005

(30) Foreign Application Priority Data
Dec. 28, 2004 (JP) 2004-382165

(51) Int. Cl. G06F 12/00

(52) U.S. Cl. 711/170; 711/162

(57) ABSTRACT

The present invention relates to a storage device which is defined by a logical volume, and makes it possible to perform processing, such as duplication of a logical volume, without using environmental construction and hardware resources of a host server side. The storage device has a storage part (a storage), which is constituted by a recordable storage medium and is defined by one or a plurality of logical volumes, and a storage control part (a storage server) which controls operation of the storage part. For control of the operation of the storage part defined by the logical volume, management information which is stored in a data base part (a data base) is referenced.

### BACKGROUND OF THE INVENTION

1. Field of the Invention

The present invention relates to data storage which uses a recordable storage medium, such as a magnetic tape, and processing thereof. In particular, the present invention relates to a storage device which is defined by a logical volume, a data processing method thereof, a data processing program thereof and a data processing system.

2. Description of the Related Art

A storage device which stores various kinds of data is defined by a logical volume, and processing such as duplication and a data copy is executed to this logical volume by a requirement from a host server. For the storage device, a recordable storage medium such as a magnetic tape is used. In this recordable storage medium, a position is changed from an old data to the latest data to add in sequence, and a data is stored. A data of this storage device is managed by a host server which is an external device.

By the way, as prior arts connected with such a storage device, the following technologies are known, for example. That is, there is a technology in which logical volumes divided into a plurality of parts are integrated into one by copying the logical volumes to a physical continuous area through a copying means (for example, a patent document 1 which is the Japanese Patent Laid Open Publication No. 2002-236560). Further, there is a technology concerning a re-organization processing method of a logical volume composed of a recordable storage medium (for example, a patent document 2 which is the Japanese Patent Laid Open Publication No. 2002-297431). According to this, a registration of a medium face which has an ineffective area is deleted from a volume, this medium face is formatted, and the formatted medium face is registered with the volume again. Further, there is a technology in which the data of a backup object is stored in a storage device that is accessed for the unit of a block in a predetermined size, and in which a position of the block in the storage device and its backup generation are also stored in a backup device (for example, a patent document 3 which is the Japanese Patent Laid Open Publication No. 9-101912). Furthermore, there is a technology concerning the data writing control of a recordable type, which sets a logical volume in an optical disk library (for example, a patent document 4 which is the Japanese Patent Laid Open Publication No. 2000-137639). According to this, file management is performed by a data base which stores a data by the indication of a file name, a directory name and so on, and processing such as allocation of a volume and file deletion is performed by this file management.

By the way, in case of making out the duplication of a specified logical volume from a host server in regard to logical volumes which are defined in a storage device, it is necessary to read in a data from a logical volume of a duplication source after making out a new logical volume, and to write the data in a logical volume of a duplication destination. Further, in a recordable storage medium, even if an old data remains on the storage medium after performing a data update, it is impossible to read out that old data. In order to read out the old data, it is necessary to use software for exclusive use, and it is necessary to access by managing a data on the storage medium by a host server.

According to such data processing by a host server, it is necessary to give environmental construction on the host server and hardware resources of a CPU (Central Processing Unit), a memory and so on. Further, in order to make out the duplication of a logical volume which is defined on a storage, processing by the host server is needed. Furthermore, in a recordable storage medium, the taking-out of an old data is non-efficient, and requires trouble. The problems mentioned above are not at all suggested in the publications No. 2002-236560, No. 2002-297431, No. 9-101912 and No. 2000-137639, and constitution to solve these problems is not disclosed or suggested, either.

### SUMMARY OF THE INVENTION

The present invention relates to a storage device which is defined by a logical volume, and an object of the present invention is to make it possible to perform processing such as duplication of a logical volume without using environmental construction and hardware resources of a host server side.

Another object of the present invention, further, is to make it possible to perform processing such as duplication of a logical volume regardless of old and new data.

In order to solve the above-mentioned problems, a storage device of the present invention is a constitution which comprises a storage part that is constituted by a recordable storage medium and is defined by one or a plurality of logical volumes, and a storage control part that controls operation of the storage part.

The storage device of a constitution like this has the storage part which stores a data, and the storage control part which controls the operation of this storage part, in its inside. The storage part is constituted by the recordable storage medium, is defined by one or the plurality of logical volumes, and stores a data. That is, one or the plurality of logical volumes is defined in the storage part by the storage control part, and the storage of a data is executed. Such operation is executed in an inside of the storage device. Hence, making of a logical volume and data processing are performed without using a host server, which is an external device, and other hardware resources. Therefore, the environmental construction of the host server and the hardware resources such as a CPU and a memory becomes unnecessary.

In order to solve the above-mentioned problems, a storage device of the present invention is a constitution which comprises a storage part, constituted by a recordable storage medium, in which one or a plurality of logical volumes is defined, a data base part that stores management information of a data of the storage part, and a storage control part that controls operation of the storage part by referring to the management information of the data base part.

The storage device of a constitution like this has the storage part in which the at least one logical volume is defined, the data base part which stores the management information, and the storage control part, in its inside. The operation of this storage part is controlled by the storage control part, and the management information of the data base part is made reference for that control. That is, the processing including a logical volume defined in the storage part and data storage is performed by referring to the management information of the data base part. Therefore, for processing like this, it is not necessary to use other hardware resources of a host server side.

In order to solve the above-mentioned problems, a storage device of the present invention is a constitution which comprises a first storage part that stores a data temporally, a second storage part that is constituted by a recordable storage medium and is defined by one or a plurality of logical volumes, and a storage control part that controls operation of either or both of the first storage part and the second storage part, and that makes the data transferred from the first storage part store in the second storage part.

The storage device of a constitution like this has the first storage part which stores a data temporally, the second storage part in which one or the plurality of logical volumes is defined, and the storage control part, in its inside. The first storage part is constituted by a random access storage medium and so on, and stores temporally the data to store in the second storage part. The second storage part is constituted by the recordable storage medium, is defined by one or the plurality of logical volumes, and stores the data. That is, a data storage of the first storage part and one or the plurality of logical volumes which is defined in the second storage part are controlled by the storage control part, and the processing, for example, in which the data of the first storage part is transferred to the second storage part and is stored therein, is executed. Operation like this is executed in an inside of the storage device. Hence, making of a logical volume and data processing are performed without using a host server, which is an external device, and other hardware resources. Therefore, also by a constitution like this, the environmental construction of a host server and the hardware resources such as a CPU and a memory become unnecessary.

In order to solve the above-mentioned problems, a storage device of the present invention is a constitution which comprises a first storage part that stores a data temporally, a second storage part, constituted by a recordable storage medium, in which one or a plurality of logical volumes is defined, the second storage part storing the data transferred from the first storage part, a data base part that stores management information of data of the first storage part and the second storage part, and a storage control part that controls operation of either or both of the first storage part and the second storage part by referring to the management information of the data base part.

The storage device of a constitution like this has the first storage part which stores a data temporally, the second storage part in which one or the plurality of logical volumes is defined, the data base part which stores the management information, and the storage control part, in its inside. As described previously, the first storage part is constituted by the random access storage medium and so on, and stores temporally the data to store in the second storage part. The constitution of the second storage part is as mentioned previously. The operation of either or both of these first and second storage parts is controlled by the storage control part, and the management information of the data base part is referenced for that control. That is, each piece of processing, such as data storage of the first storage part, a logical volume which is defined in the second storage part, and data storage thereof, is performed by referring to the management information of the data base part. Therefore, in such processing, it is not necessary to use other hardware resources of a host server side.

In order to solve the above-mentioned problems, a storage device of the present invention is a constitution which comprises a storage part, constituted by a recordable storage medium, in which one or a plurality of logical volumes is defined, and a storage control part that makes out a duplicated logical volume in the storage part by receiving a duplication requirement of a logical volume from an outside, and that also makes a data of an existing logical volume store in this duplicated logical volume.

The storage device of a constitution like this has the storage part in which at least one logical volume is defined, and the storage control part, in its inside. Therefore, if the requirement of duplication processing is given from the outside, the storage device responds to that requirement, and the duplication processing of a logical volume is executed. Processing like this is performed in the storage device without using other hardware resources of a host server side.

In order to solve the above-mentioned problems, a storage device of the present invention has a first storage part that stores a data temporally, a second storage part, constituted by a recordable storage medium, in which one or a plurality of logical volumes is defined, and a storage control part that makes out a duplicated logical volume in the storage part by receiving a duplication requirement of a logical volume from an outside, and that also writes a data of an existing logical volume in this duplicated logical volume through an intermediary of the first storage part.

The storage device of a constitution like this has the first storage part which stores a data temporally, the second storage part in which at least one logical volume is defined, and the storage control part, in its inside. Therefore, if the requirement of duplication processing is given from the outside, the storage device responds to that requirement, and the duplication processing of a logical volume, for example, processing which stores the data in the first storage part, processing which makes out a logical volume at the second storage part, and processing which stores the data in this logical volume, is executed. Such processing is performed in the storage device without using other hardware resources of a host server side.

In order to solve the above-mentioned problems, a data processing method of a storage device according to the present invention is a data processing method of a storage device which uses a recordable storage medium, and is a constitution which includes processing that defines one or a plurality of logical volumes in a storage part which is constituted by the recordable storage medium, and processing that controls operation of the storage part.

According to a constitution like this, in the storage device, the operation of the storage part which is constituted by the recordable storage medium is controlled, and one or the plurality of logical volumes is also defined in the storage part by that control. Processing like this is executed in an inside of the storage device, and making of a logical volume and data processing are executed in the inside of the storage device without using a host server, which is an external device, and other hardware resources. Therefore, the environmental construction of a host server and the hardware resources such as a CPU and a memory are unnecessary.

In order to solve the above-mentioned problems, a data processing method of a storage device according to the present invention is a data processing method of a storage device which uses a recordable storage medium, and is a constitution which includes processing that defines one or a plurality of logical volumes in a storage part constituted by the recordable storage medium, processing that stores management information of a data of the storage part in a data base part, and processing that controls operation of the storage part by referring to the management information of the data base part.

According to the data processing method of a constitution like this, one or the plurality of logical volumes is defined in the storage part which is constituted by the recordable storage medium, and the management information of this storage part is stored in the data base part. Therefore, in the control of the operation of the storage part, the processing such as definition of a logical volume and storage of a data is executed by referring to the management information of the data base part.

A data processing method of a storage device according to the present invention is a data processing method of a storage device which uses a recordable storage medium, and may be a constitution which includes processing that stores a data in a first storage part temporally, processing that defines one or a plurality of logical volumes in a second storage part constituted by the recordable storage medium, and processing that controls operation of either or both of the first storage part and the second storage part, and that makes the data transferred from the first storage part store in the second storage part.

A data processing method of a storage device according to the present invention is a data processing method of a storage device which uses a recordable storage medium, and may be a constitution which includes processing that stores a data in a first storage part temporally, processing that defines one or a plurality of logical volumes in a second storage part constituted by the recordable storage medium, processing that stores management information of data of the first storage part or the second storage part in a data base part, processing that controls operation of either or both of the first storage part and the second storage part by referring to the management information of the data base part, and processing that makes the data transferred from the first storage part store in the second storage part.

A data processing method of a storage device according to the present invention is a data processing method of a storage device which uses a recordable storage medium, and may be a constitution which includes processing that defines one or a plurality of logical volumes in a storage part constituted by the recordable storage medium, processing that makes out a duplicated logical volume in the storage part by receiving a duplication requirement of a logical volume from an outside, and processing that makes a data of an existing logical volume store in the duplicated logical volume.

A data processing method of a storage device according to the present invention is a data processing method of a storage device which uses a recordable storage medium, and may be a constitution which includes processing that stores a data in a first storage part temporally, processing that defines one or a plurality of logical volumes in a second storage part constituted by the recordable storage medium, processing that makes out a duplicated logical volume in the storage part by receiving a duplication requirement of a logical volume from an outside, and processing that writes a data of an existing logical volume in the duplicated logical volume through an intermediary of the first storage part.

In order to solve the above-mentioned problems, a data processing program of a storage device according to the present invention is a data processing program of a storage device, which is executed by a computer, and is a constitution which includes a step that defines one or a plurality of logical volumes in a storage part constituted by a recordable storage medium, and a step that controls operation of the storage part.

According to the data processing program of a constitution like this, the operation of the storage part in the storage device is controlled, and one or the plurality of logical volumes is defined in the storage part. By the processing of a program like this, it is possible to perform processing, such as duplication of a logical volume and a copy of a data, without being assisted by an external host server and so on.

A data processing program of a storage device according to the present invention is a data processing program of a storage device, which is executed by a computer, and may be a constitution which includes a step that defines one or a plurality of logical volumes in a storage part constituted by the recordable storage medium, a step that makes management information of a data of the storage part store in a data base part, and a step that controls operation of the storage part by referring to the management information of the data base part.

A data processing program of a storage device according to the present invention is a data processing program of a storage device, which is executed by a computer, and may be a constitution which includes a step that makes a data store in a first storage part temporally, a step that defines one or a plurality of logical volumes in a second storage part constituted by the recordable storage medium, and a step that controls operation of either or both of the first storage part and the second storage part, and that makes the data transferred from the first storage part store in the second storage part.

A data processing program of a storage device according to the present invention is a data processing program of a storage device, which is executed by a computer, and may be a constitution which includes a step that makes a data store in a first storage part temporally, a step that defines one or a plurality of logical volumes in a second storage part constituted by the recordable storage medium, a step that makes management information of data of the first storage part or the second storage part store in a data base, a step that controls operation of either or both of the first storage part and the second storage part by referring to the management information of the data base part, and a step that makes the data transferred from the first storage part store in the second storage part.

A data processing program of a storage device according to the present invention is a data processing program of a storage device, which is executed by a computer, and may be a constitution which includes a step that defines one or a plurality of logical volumes in a storage part constituted by the recordable storage medium, a step that makes out a duplicated logical volume in the storage part by receiving a duplication requirement of a logical volume from an outside, and a step that makes a data of an existing logical volume store in the duplicated logical volume.

A data processing program of a storage device according to the present invention is a data processing program of a storage device, which is executed by a computer, and may be a constitution which includes a step that makes a data store in a first storage part temporally, a step that defines one or a plurality of logical volumes in a second storage part constituted by the recordable storage medium, a step that makes out a duplicated logical volume in the storage part by receiving a duplication requirement of a logical volume from an outside, and a step that writes a data of an existing logical volume in the duplicated logical volume through an intermediary of the first storage part.

In order to solve the above-mentioned problems, a data processing system of the present invention is a data processing system which has a storage device using a recordable storage medium, and the storage device is a constitution which comprises a storage part, constituted by the recordable storage medium, in which one or a plurality of logical volumes is defined, and a storage control part that controls operation of the storage part. Giving a constitution like this, the data processing is executed by the storage device as mentioned previously, and the load of a host server which is an external device of the storage device is to be reduced.

A data processing system of the present invention is a data processing system which has a storage device using a recordable storage medium, and the storage device may be a constitution which comprises a storage part, constituted by the recordable storage medium, in which one or a plurality of logical volumes is defined, a data base part that stores management information of a data of the storage part, and a storage control part that controls operation of the storage part by referring to the management information of the data base part.

A data processing system of the present invention is a data processing system which has a storage device using a recordable storage medium, and the storage device may be a constitution which comprises a first storage part that stores a data temporally, a second storage part that is constituted by the recordable storage medium and is defined by one or a plurality of logical volumes, and a storage control part that controls operation of either or both of the first storage part and the second storage part, and that makes the data transferred from the first storage part store in the second storage part.

A data processing system of the present invention is a data processing system which has a storage device using a recordable storage medium, and the storage device may be a constitution which comprises a first storage part that stores a data temporally, a second storage part, constituted by the recordable storage medium, in which one or a plurality of logical volumes is defined, the second storage part storing the data transferred from the first storage part, a data base part that stores management information of data of the first storage part and the second storage part, and a storage control part that controls operation of either or both of the first storage part and the second storage part by referring to the management information of the data base part.

A data processing system of the present invention is a data processing system which has a storage device using a recordable storage medium, and the storage device may be a constitution which comprises a storage part, constituted by the recordable storage medium, in which one or a plurality of logical volumes is defined, and a storage control part that makes out a duplicated logical volume in the storage part by receiving a duplication requirement of a logical volume from an outside, and that also makes a data of an existing logical volume store in the duplicated logical volume.

A data processing system of the present invention is a data processing system which has a storage device using a recordable storage medium, and the storage device may be a constitution which comprises a first storage part that stores a data temporally, a second storage part, constituted by the recordable storage medium, in which one or a plurality of logical volumes is defined, and a storage control part that makes out a duplicated logical volume in the storage part by receiving a duplication requirement of a logical volume from an outside, and that also writes a data of an existing logical volume in the duplicated logical volume through an intermediary of the first storage part.

In order to solve the above-mentioned problems, a storage device of the present invention is a storage device which has a storage part that is constituted by a recordable storage medium, and a storage control unit that is connected to the storage part and controls operation of the storage part, and may also be constituted as mentioned below. The storage part is defined by one or a plurality of logical volumes that is constituted by one or a plurality of logical blocks. The storage control unit has a data base part in which a logical volume management table provided at each logical volume is defined, and in which a logical block management table provided at each logical block constituting the logical volume is defined. Further, in the logical volume management table, a logical block management table pointer that indicates the logical block management table of each logical block is set. Furthermore, in the logical block management table, position information of a data corresponding to a concerned logical block and a pre-logical-block management table pointer that is made to correspond to a logical block management table concerning a pre-data before an update of the data are set.

By a constitution like this, the data which is stored in the storage part defined by one or the plurality of logical volumes is related by the management information which is stored in the data base part. Hence, on both of old and new data, it is possible to optionally perform data processing, such as making of the duplication of a logical volume and taking-out of old and new data, by referring to the management information.

In order to solve the above-mentioned problems, a storage device of the present invention is a storage device which has a storage part that is constituted by a recordable storage medium, and a storage control unit that is connected to the storage part and controls operation of the storage part, and may also be constituted as mentioned below. The storage part is defined by one or a plurality of logical volumes that is constituted by one or a plurality of logical blocks. A data base part is connected to the storage control unit. In the data base part, a logical volume management table provided at each logical volume is defined, and a logical block management table provided at each logical block constituting the logical volume is also defined. Further, in the logical volume management table, a logical block management table pointer that indicates the logical block management table of each logical block is set. Furthermore, in the logical block management table, position information of a data corresponding to a concerned logical block and a pre-logical-block management table pointer that is made to correspond to a logical block management table concerning a pre-data before an update of the data are set.

By a constitution like this, even if the data base part is connected to an outside of the storage control unit, it is possible to similarly execute the data processing mentioned previously.

In order to solve the above-mentioned problems, a data base of the present invention is a data base connected to a storage control unit controlling operation of a storage part which is constituted by a recordable storage medium and is defined by one or a plurality of logical volumes constituted by one or a plurality of logical blocks, and is constituted as mentioned below. In the data base, a logical volume management table provided at each logical volume is defined, and a logical block management table provided at each logical block constituting the logical volume is also defined. Further, in the logical volume management table, a logical block management table pointer that indicates the logical block management table of each logical block is set. Furthermore, in the logical block management table, position information of a data corresponding to a concerned logical block and a pre-logical-block management table pointer that is made to correspond to a logical block management table concerning a pre-data before an update of the data are set.

In order to solve the above-mentioned problems, a storage control unit of the present invention is a storage control unit which is connected to a storage part constituted by a recordable storage medium and defined by one or a plurality of logical volumes constituted by one or a plurality of logical blocks and controls operation of the storage part, and is constituted as mentioned below. The storage control unit has a data base part in which a logical volume management table provided at each logical volume of the storage part is defined, and in which a logical block management table provided at each logical block constituting the logical volume is also defined. Further, in the logical volume management table, a logical block management table pointer that indicates the logical block management table of each logical block is set. Furthermore, in the logical block management table, position information of a data corresponding to a concerned logical block and a pre-logical-block management table pointer that is made to correspond to a logical block management table concerning a pre-data before an update of the data are set.

In order to solve the above-mentioned problems, a storage control unit of the present invention is a storage control unit which is connected to a storage part constituted by a recordable storage medium and defined by one or a plurality of logical volumes constituted by one or a plurality of logical blocks and controls operation of the storage part by using management information stored in a data base part, and is constituted as mentioned below. In the data base part, a logical volume management table provided at each logical volume of the storage part is defined, and a logical block management table provided at each logical block constituting the logical volume is also defined. Further, in the logical volume management table, a logical block management table pointer that indicates the logical block management table of each logical block is set. Furthermore, in the logical block management table, position information of a data corresponding to a concerned logical block and a pre-logical-block management table pointer that is made to correspond to a logical block management table concerning a pre-data before an update of the data are set.

In order to solve the above-mentioned problems, a storage medium of the present invention is a constitution which stores the data processing program mentioned previously.

As described above, the present invention relates to the data storage, which uses the recordable storage medium such as a magnetic tape, and the processing thereof. In particular, it is possible to independently perform the data processing, such as duplication of a logical volume defined in the storage part and a copy of data, at the storage device without using the environmental construction and the hardware resources of a host server side. Further, it is possible to perform the copy of data and the duplication of a logical volume regardless of old and new data. Hence, it is possible to contribute to improvement of the efficiency of data processing.

Furthermore, enumerating the featured matters and advantages of the present invention, these are as in the following.

(1) It is possible to easily perform the processing, such as taking-out of an old data and duplication and an update of a logical volume, without using the environmental construction on a host server and the hardware resources of a CPU, a memory and so on, and what is more, it is possible to efficiently perform this processing.

(2) Since the hardware resources of a host sever are not used for the processing such as duplication and an update of a logical volume, it is possible to avoid an influence of performance deterioration of a job operating on the host server.

(3) It is possible to perform the processing, such as duplication of a logical volume, regardless of old and new data, and it is possible to efficiently take out the old data.

(4) Since it is possible to perform the duplication of a logical volume of an old data, the restoration of data becomes possible, for example, even in case of performing the overwriting of data by mistake.

### BRIEF DESCRIPTION OF THE DRAWINGS

The foregoing and other objects, features and attendant advantages of the present invention will be appreciated as the same become better understood by means of the following description and accompanying drawings wherein:

FIG. 1 is a drawing showing a data processing system according to a first embodiment;

FIG. 2 is a drawing showing another data processing system according to the first embodiment;

FIG. 3 is a drawing showing the composition image of a logical volume;

FIG. 4 is a drawing showing a data state image at different time points of a logical volume;

FIG. 5 is a drawing showing a data state image concerned with a data copy;

FIG. 6 is a flow diagram showing the procedure of duplication processing of a logical volume;

FIG. 7 is a drawing showing the management information of a logical volume management table and a logical block management table of a data base;

FIG. 8 is a drawing showing duplication items in a data base;

FIG. 9 is a drawing showing the processing sequence of data writing processing;

FIG. 10 is a drawing showing a data processing system according to a second embodiment;

FIG. 11 is a drawing showing another data processing system according to the second embodiment;

FIG. 12 is a flow diagram showing the processing procedure of duplication processing of a logical volume; and

FIG. 13 is a drawing showing the processing sequence of data writing processing.

### DETAILED DESCRIPTION OF THE PREFERRED EMBODIMENTS

### First Embodiment

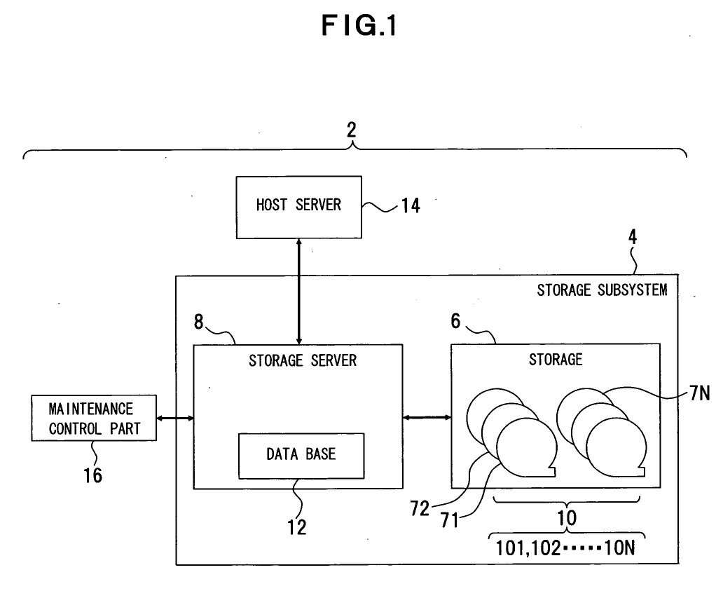

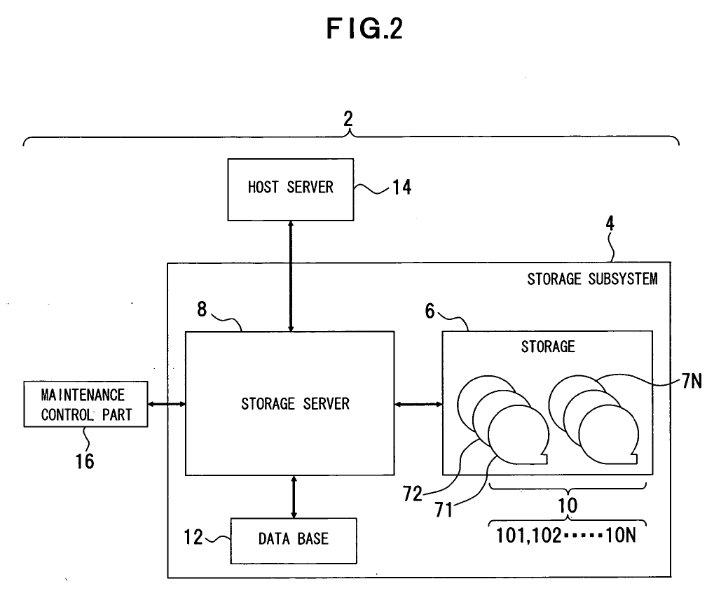

A first embodiment of the present invention is explained by referring to FIG. 1 and FIG. 2. FIG. 1 is a drawing showing a data processing system according to the first embodiment, and FIG. 2 is a drawing showing a modified example thereof.

In this data processing system 2, for example, a storage subsystem 4 is installed as a storage device of data. In this storage subsystem 4, a storage 6 is provided as a storage part, and a storage server 8 is also provided as a storage control unit. In the embodiment shown in FIG. 1, a data base 12 is provided as a data base part in the storage server 8. As shown in the embodiment of FIG. 2, for example, this data base 12 may also be constituted separately from the storage server 8. In the storage 6, for example, a plurality of storage mediums 71, 72 . . . 7N which consist of a recordable storage medium of a magnetic tape and so on is installed, and one or a plurality of logical volumes 10 is defined in these storage mediums 71 through 7N. For example, one or the plurality of logical volumes 10 is constituted by logical volumes 101, 102 . . . 10N. The storage server 8 is used for control of the definition of the logical volumes 101, 102 . . . 10N, the reading and writing of a data, and so on. The data base 12 is constituted by using a storage medium on the storage server 8, and management information of the storage 6 is stored therein. In this management information, for example, various kinds of pieces of information necessary for data management, such as capacity of the storage 6, size of one or the plurality of logical volumes 10, position information of a data, writing time information and state information, are included. Further, a host server 14 is an external device of the storage subsystem 4, and, for example, is constituted by a computer. The host server 14 is used for the writing-in and reading-out of a data toward the storage 6. Furthermore, a maintenance control part 16 is constituted by a computer, for example, and constitutes an interface which performs maintenance, setting and so on of the storage subsystem 4.

In the storage subsystem 4 of a constitution like this, in case in which a data writing requirement is performed toward the storage subsystem 4 from the host server 14, access is performed to a data on the storage 6 by way of the storage server 8. At this time, with a data change on the storage 6, an update of the management information of the data base 12 of the storage server 8 is performed. In the data base 12, a data representative of a writing time, a position, a size and so on of all data on the storage mediums 71, 72 . . . 7N which constitute the logical volumes 10 (=101, 102 . . . 10N) defined in the storage 6 is stored, and that data is managed.

According to a constitution like this, by receiving a command from the host server 14, in the storage subsystem 4 it is possible to control operation of the storage 6 by the storage server 8. Various kinds of pieces of information representative of the progress of control thereof and so on are stored in the data base 12 as the management information, and the control of the storage 6 is managed by the management information which exists in the data base 12. In this storage subsystem 4, if the storage subsystem 4 receives the command from the host server 14, it is possible to execute various kinds of pieces of processing, such as duplication of the logical volumes 10, by referring to the management information which exists in the data base 12. Moreover, such processing can be executed without using environmental construction and hardware resources, such as a CPU and a memory, of a side of the host server 14. Further, in case in which the storage 6 is constituted by the recordable storage medium, an old data which remains in the storage 6 can be taken out by referring to the management information existing in the data base 12, efficiently.

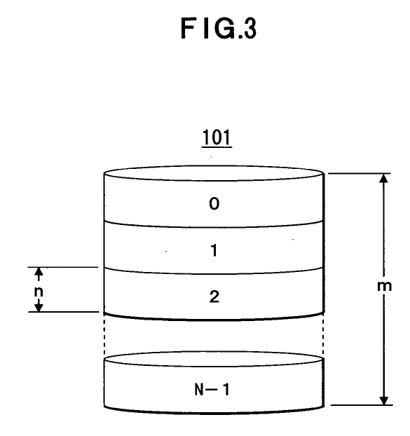

Next, the composition of a logical volume is explained by referring to FIG. 3. FIG. 3 is a drawing showing an image of a logical volume defined in the storage.

In connection with one or the plurality of logical volumes 10, the logical volume 101 which is one of them, for example, is identified by a plurality of logical blocks 0, 1. . . N−1. If the size of this logical volume is represented by “m” and the size of the logical block is represented by “n”, the number of logical blocks “N” is given by the following expression.
N=m (the size of logical volume)/n (the size of logical block) (1)

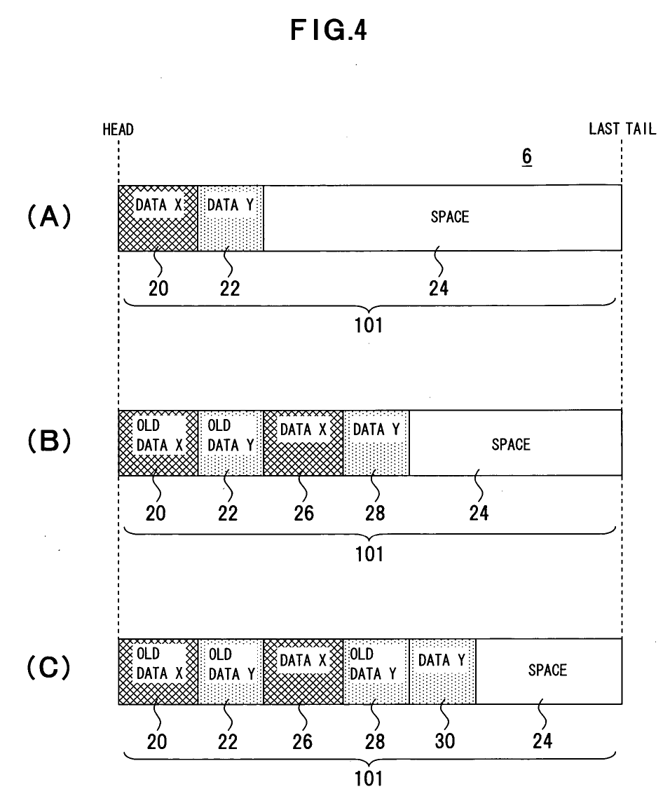

Next, the storage processing of a data of a storage medium is explained by referring to FIG. 4. FIG. 4 is a drawing showing a data state image at different time points of the logical volume.

Since the logical volume 101 is constituted by the storage mediums 71, 72 . . . 7N which are the recordable storage medium, the writing-in or the update of a data is performed by a form added toward its tail from its head. In this storage transition of data, FIG. 4(A) shows the additional writing of a data, and FIG. 4(B) and FIG. 4(C) show a data update.

In an image of a data state shown in FIG. 4(A), for example, a data X 20 is written in toward the tail from the head of the logical volume 101, and a data Y 22 is added at a side of the tail of this data X 20. In this case, the logical volume 101 is under a state that the data X 20 and the data Y 22 are written respectively once in sequence. And, at the back part of the data Y 22, a space area 24 comes toward the last tail.

An image of a data state shown in FIG. 4(B) shows a state that is updated from the data state shown in FIG. 4(A). In this case, a state that each of a data X 26 and a data Y 28 is updated once in sequence is shown. The data X 20 and the data Y 22 (FIG. 4(A)) are an old data, and the data X 26 and the data Y 28 are an updated data which is added. As a result of this data update, the space area 24 narrows. In connection with a relation between a data update like this and a data reading-in requirement, in case in which the data reading-in requirement is performed from the host server 14, the data X 26 and the data Y 28 (the updated data) are to be sent from the storage 6 to the host server 14, and it is impossible to read the data X 20 and the data Y 22 (the old data).

Further, an image of a data state shown in FIG. 4(C) shows a state that is updated from the data state shown in FIG. 4(B). This state is a state that the data Y 28 is added and re-updated. The data Y 28 becomes an old data. In case in which the data reading-in requirement is performed from the host server 14, the data X 26 and a data Y 30 are to be sent to the host server 14, and it is impossible to read the data Y 28 which is the old data.

Now, if making the duplication of the logical volume 101 is instructed toward the storage subsystem 4 from the maintenance control part 16 at the time point shown in FIG. 4(C), the management information which exists in the data base 12 on the storage server 8 is referenced, and the duplication processing is performed. Here, information representative of a data state on the storage medium 71 which constitutes the logical volumes 10 is stored in the data base 12, and, in particular, information concerning a data before an update is stored in the data base 12. Hence, by utilizing this information, it is possible to make out not only the duplication of the state of the data state image shown in FIG. 4(C) but also the duplication of the state of data state image shown in FIG. 4(A) or the data state image shown in FIG. 4(B). That is, by referring to the management information of the data base 12, it is possible to make out the duplication of the logical volumes 10 regardless of the old and new data.

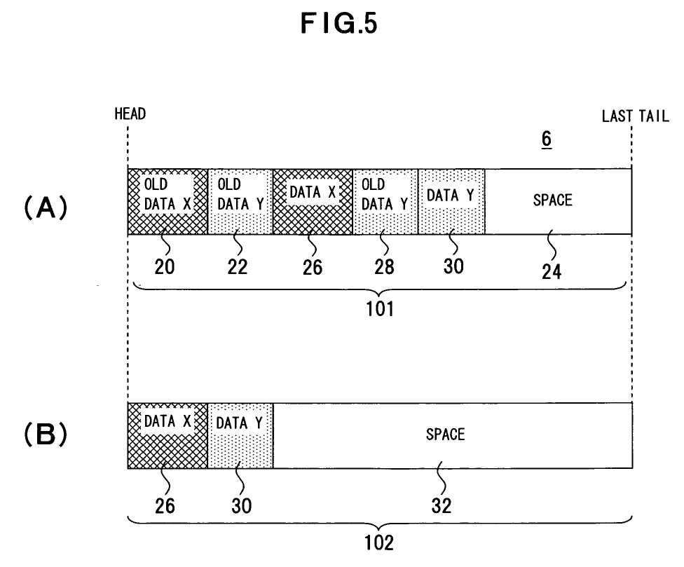

Next, the data copy processing of a storage medium is explained by referring to FIG. 5. FIG. 5 is a drawing showing an image of a data state in case of performing a copy by using only the latest data from the data state shown in FIG. 4(C).

In this processing, simple duplication of the logical volume 101 is not performed, but it is possible to write only the latest data of each data state in a copy destination, for example, in the logical volume 102. That is, FIG. 5(A) shows the data state of the logical volume 101 of a copy source, and is the same as FIG. 4(C). Against this, FIG. 5(B) shows a data state of the logical volume 102 of the copy destination. In this case, the data X 26 and the data Y 30 which are the newest data are used from the data state image shown in FIG. 5(A), and a data state image in which these data are copied in the logical volume 102 is shown. Like this, only the necessary data of the logical volume 101 is copied, and the logical volume 102 is formed. As a result of this, the data X 26 and the data Y 30 are copied in the logical volume 102 of the copy destination. In this case, a space area 32 exists in the logical volume 102.

Like this, in connection with the logical volumes 10, it is possible to perform the making of the duplication of a logical volume and the copy of a data. The making of the duplication of a logical volume means that a logical volume is newly defined, and that another logical volume which stores the same data and has a different logical volume number is made out by copying a new or old data in the newly defined logical volume. Further, the copy of a data means a copy of a data on the recordable storage mediums 71 through 7N constituting the storage 6 in which the logical volumes 10 are defined, and a copy of a data into a defined logical volume.

These pieces of processing are executed by using the storage 6, the storage server 8 and the data base 12 of the storage subsystem 4 (FIG. 1, FIG. 2), and the hardware resources and the software resources of the side of the host server 14 are not used for such processing. Because of this, there is nothing that such processing influences a job operating on the host server 14, and there is nothing to cause the influence of performance deterioration and so on to the job on the host server 14, either. Further, since the duplication of the logical volumes 10 is performed by using the management information which is stored in the database 12, it is possible to identify a data at an optional time point of the past, namely an old data, from the management information of the database 12, and it is possible to copy the identified data in a defined logical volume. Because of this, it is possible to make out the duplication of the logical volumes 10 relative to an old data. Like this, by referring to the management information, it is possible to make out the duplication of the logical volumes 10 which store the old and new data. Because of this, the restoration of a data becomes possible as the need arises, and, for example, it is possible to perform the restoration of a data with ease even in case of performing the overwriting of a data by mistake.

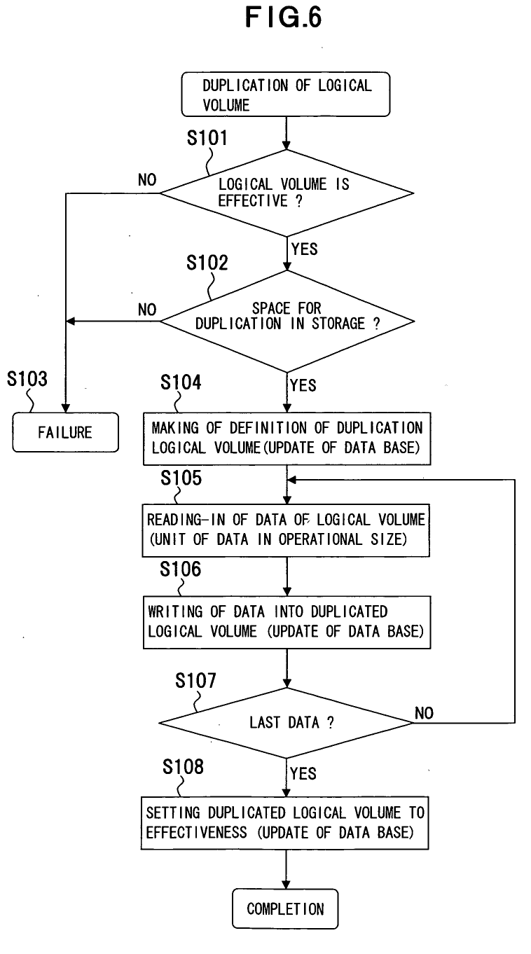

Next, the duplication processing of a logical volume is explained by referring to FIG. 6. FIG. 6 is a flow diagram showing the processing procedure of a processing method and a processing program of the duplication processing of a logical volume, which is an embodiment of a data processing method according to the present invention.

In this duplication processing, processing based on a duplication instruction of a logical volume from the maintenance control part 16 is performed, and, as the logical volumes 10 which are a duplicated object, for example, the processing concerning the logical volumes 101 and 102 is executed.

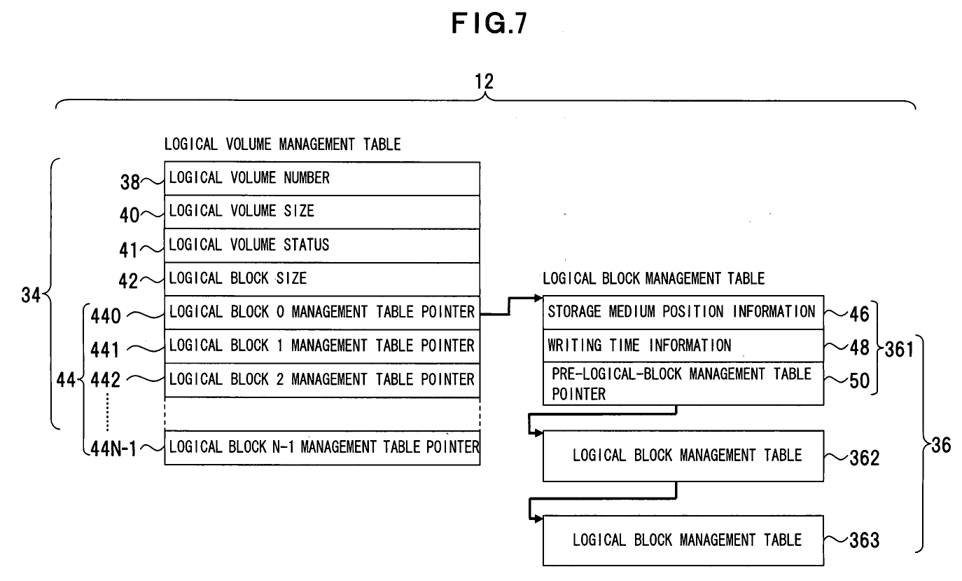

If the storage server 8 (FIG. 1, FIG. 2) receives a command of the duplication processing of the logical volume 101 from the maintenance control part 16, whether or not the logical volume 101 is effective is decided by management information (a step S101). For this decision, the management information which is stored in the data base 12 is referenced. To put it concretely, state information concerning the logical volume 101 which is stored in logical volume status 41 of a logical volume management table 34 (FIG. 7) is referenced. In case in which the logical volume 101 is effective, whether or not there is a space for the purpose of making out the duplication of the logical volume 101 in the storage 6 is decided (a step S102). Also in this decision, the management information which is stored in the data base 12 is referenced. That is, by comparing the size of the logical volume 101, which is duplicated, with a space capacity in the storage mediums 71 through 7N which constitute the storage 6, whether or not the space able to make out the duplication of the logical volume 101 exists in the storage 6 is decided. The size of the logical volume 101 is information which is stored in a logical volume size 40 of the logical volume management table 34 (FIG. 7). And, in case in which the logical volume 101 is not effective (the step S101), or in case in which there is no space for the purpose of making out the duplication of the logical volume 101 in the storage 6 (the step S102), it is impossible to execute the duplication processing of the logical volume 101 (a step S103).

In case in which the space exists in the storage 6, the definition of the duplicated logical volume 102 is made out. Along with this, regarding the making of that definition and so on, the management information of the data base 12 is updated (a step S104), and a data of the logical volume 101 is read in (a step S105). In this case, the reading-in of data is performed with the unit of a data in an optional size.

After this reading-in of data, this data is written in the logical volume 102 duplicated, and, with this writing-in, an update of the management information in the data base 12 is performed (a step S106). This writing-in of data is continued until all data are completed (the step S105—the step S106—a step S107). In case in which the last data arrives from the logical volume 101, the duplicated logical volume 102 is set to effectiveness, and, with this setting of the effectiveness, the update processing of the management information of the data base 12 is executed (a step S108).

By processing like this, it is possible to complete the writing-in of data into the duplicated logical volume 102 by the duplication processing of the logical volume 101, and the duplication of the logical volume 101 is made out. In addition, as described previously, this duplication processing is independently executed at the side of the storage subsystem 4, and is performed without imposing any load on the host server 14.

Next, the logical volume management of the data base is explained by referring to FIG. 7. FIG. 7 is a drawing showing the management information of a logical volume management table and a logical block management table of the data base.

In order to store the management information of the logical volumes 10, the data base 12 (FIG. 1, FIG. 2) has a logical volume management table 34, logical block management tables 36, and so on. In the logical volume management table 34, the management information of the logical volume 101 is stored. To put it concretely, a logical volume number 38, a logical volume size 40, logical volume status 41 and a logical block size 42 are ser. Further, as logical block management table pointers 44 corresponding to the logical blocks 0, 1, 2 . . . N−1 described previously, for example, a logical block 0 management table pointer 440, a logical block 1 management table pointer 441, a logical block 2 management table pointer 442 . . . a logical block N−1 management table pointer 44N−1 are set. On the other hand, in the logical block management table 36, storage medium position information 46 which indicates the storage starting position of a data corresponding to each logical block, writing time information 48, and a pre-logical-block management table pointer 50 which indicates the position of a logical block management table concerning a pre-data just before an update at each logical block are set.

Further, the logical volume 101 is managed by the logical blocks 0, 1, . . . N−1 which are the optional-sized block unit. In the logical volume management table 34, the logical block management table pointers 440 through 44N−1 are prepared at each of the logical blocks 0, 1, . . . N−1 which exist in the logical volume 101. In case in which a data corresponding to the logical blocks 0, 1, . . . N−1 exists on the storage mediums, a pointer of the logical block management table 361 which has the latest data out of data corresponding to the logical blocks 0, 1, . . . N−1 is set. In case in which a data corresponding to the logical blocks 0, 1, . . . N−1 dose not exist on the storage mediums, “0” is set in the logical block management table pointers 44. Further, the logical block management table 361 has the position information 46 of the storage mediums and the writing time information 48 of the logical blocks 0, 1, . . . N−1. Furthermore, in the logical block management tables 36, the pre-logical-block management table pointer 50 is set. In case in which a logical block management table 362 corresponding to a data updated in the past exists, the logical block management table 361 and the logical block management table 362 are related by the pre-logical-block management table pointer 50. In FIG. 7, a logical block management table 363 is related to the logical block management table 362, similarly. In case in which a logical block management table of the past does not exist, “0” is to be set in the pre-logical-block management table pointer 50. Regarding the reference and duplication of a data before an update, in the above example, the latest data is indicated by the pre-logical-block management table pointer 50 of the logical block management table 361, and data up to that time is indicated by the logical block management tables 362, 363 . . . .

As mentioned above, since the management information is constituted and is stored in the data base 12, not only the logical volumes 10 storing the latest data, but also the management information, such as positions and states of old and new data in the storage mediums 71, 72 . . . 7N, is stored. Because of this, by referring to that management information, not only the reading-out of the latest data, but also the reading-out of an old data becomes possible. Therefore, it is possible to perform the copy of a data and the duplication of a logical volume regardless of old and new data.

In addition, processings, such as a copy of old and new data, making of a logical volume and making of duplication thereof, can be executed by only the storage subsystem 4 through the reference of the management information of the data base 12 without being attended with data processing of the side of the host server 14.

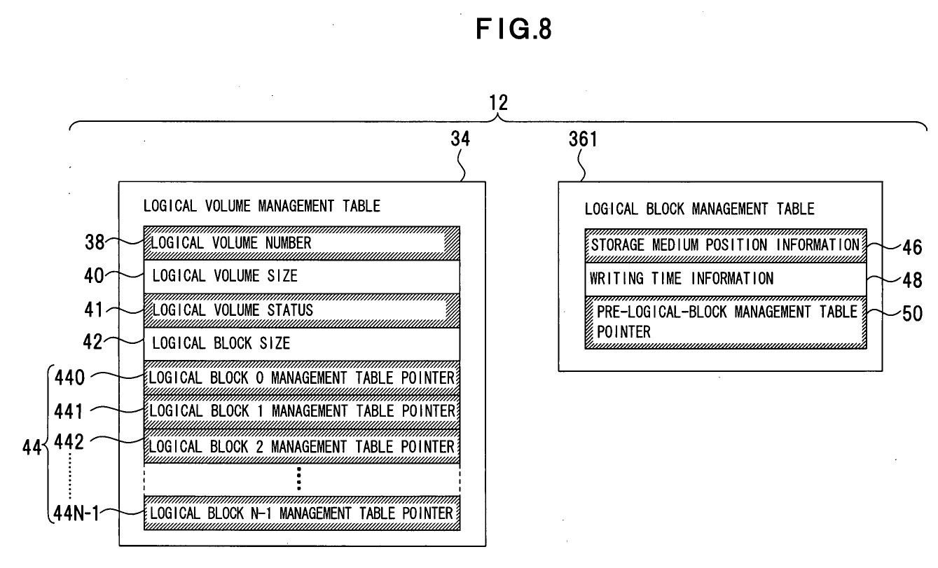

Next, duplication items of the logical volume management information are explained by referring to FIG. 8. FIG. 8 shows the duplication items in the logical volume management table and the logical block management table of the data base.

In case of performing the duplication of an optional data of the logical volumes 10, an item which needs to be set to the same value between a logical volume of a duplication source and a logical volume of a duplication destination is copied from management information of the logical volume of the duplication source to management information of the logical volume of the duplication destination. Management information except the management information copied from the duplication source is to be newly set according to the writing state of a data of a storage medium of the duplication destination. Therefore, the items of oblique line parts shown in FIG. 8 are not copied, and items except the oblique line parts are to be duplicated. That is, since the logical volume of the duplication source and the logical volume of the duplication destination do not come to the same, the oblique line parts are not copied, but information of the logical volume size 40 and so on is copied because it is the same between the duplication source and the duplication destination.

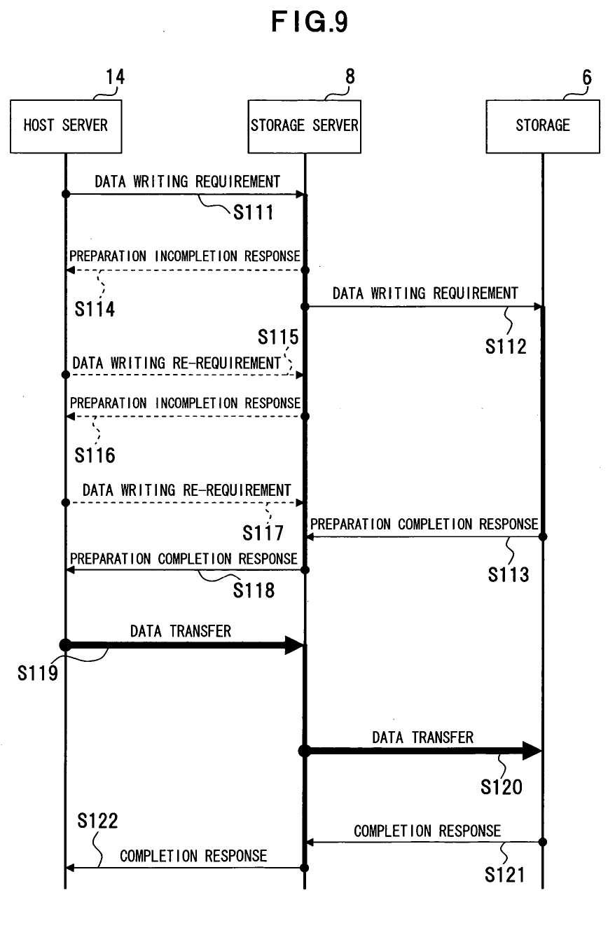

Next, a data processing method according to the first embodiment of the present invention is explained by referring to FIG. 9. FIG. 9 is a drawing showing the processing sequence of a data processing method and a data processing program corresponding to a data writing requirement of the host server of the data processing system according to the first embodiment.

This processing sequence is the processing of the storage subsystem 4 corresponding to the host server 14, and shows the data processing of the host server 14, the storage 6 and the storage server 8.

A data writing requirement is generated from the host server 14 (a step S111), and, if the storage server 8 receives this data writing requirement, a data writing requirement is given to the storage 6 (a step S112). Then, a preparation completion response is issued from the storage 6 after the completion of a preparation (a step S113).

By the way, during a period from the data writing requirement (the step S111) until the preparation completion response (the step S113) is issued, a preparation incompletion response is issued from the storage server 8 to the host server 14 (a step S114), and a data writing re-requirement is issued from the host server 14 to the storage server 8 (a step S115). Further, the preparation incompletion response is issued from the storage server 8 to the host server 14 (a step S116), and the data writing re-requirement is issued from the host server 14 to the storage server 8 (a step S117).

Then, if a preparation completion response is issued from the storage server 8 to the host server 14 (the step S118) after the preparation completion response (the step S113) is issued from the storage 6, a data transfer is performed from the host server 14 to the storage server 8 (a step S119), and the data transfer is performed to the storage 6 via the storage server 8 (a step S120). Following this, a completion response thereof is issued from the storage 6 to the storage server 8 (a step S121), and a completion response is issued from the storage server 8 to the host server 14 (a step S122). Based on processing like this, the writing-in of data into the strage 6 is executed correspondingly to the data writing requirement from the host server 14. By such writing-in of data, it is possible to perform the processing, namely the making of the duplication of a logical volume, the copy of a data, and so on.

### Second Embodiment

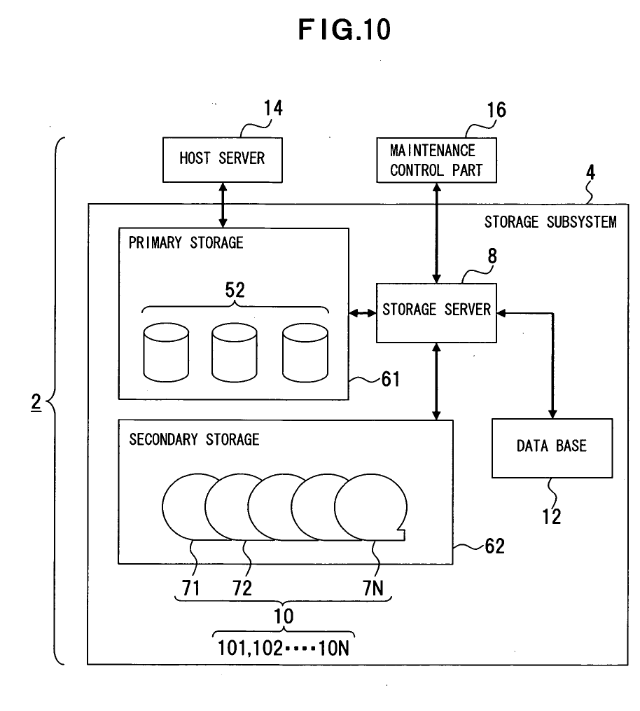

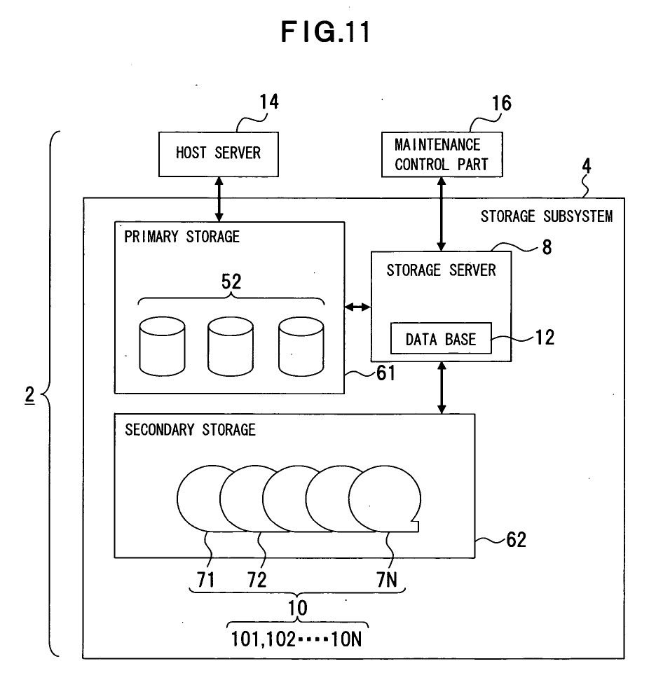

Next, a second embodiment of the present invention is explained by referring to FIG. 10 and FIG. 11. FIG. 10 is a drawing showing a data processing device according to the second embodiment, and FIG. 11 is a drawing showing a modified example thereof. Although the first embodiment has the single storage, this second embodiment has a plurality of storages. In FIG. 10 and FIG. 11, the same portions as those shown in FIG. 1 or FIG. 2 are indicated by the same reference numerals.

In a storage subsystem 4 serving as a storage device of a data processing system 2 of this embodiment, a primary storage 61 is provided as a first storage part, a secondary storage 62 is provided as a second storage part, a storage server 8 is provided as a storage control unit, and a data base 12 is provided. In this embodiment, the data base 12 is constituted separately from the storage server 8. For example, as shown in the embodiment of FIG. 11, this data base 12 may also be constituted as a data base part on the storage server 8 by using the same storage medium as the storage server 8. The primary storage 61 is constituted by a plurality of random access storage mediums 52. On the other hand, in the second storage 62, for example, a plurality of storage mediums 71, 72 . . . 7N which are constituted by a recordable storage medium of a magnetic tape and so on as described in the first embodiment is installed, and one or a plurality of logical volumes 10 is defined in these storage mediums 71 through 7N. The storage server 8 is a hierarchical server, and is used for control, such as data storage of the primary storage 61 and a data transfer to the secondary storage 62, and for control, such as definition of the logical volumes 101, 102 . . . 10N and writing and reading of a data in the secondary storage 62. The data base part 12 is constituted by using a storage medium on the storage server 8, and management information of the primary storage 61 and the secondary storage 62 is stored. This management information includes information, such as writing and reading of a data and a state of that state, in regard to the primary storage 61, and various kinds of pieces of information necessary for data management, such as a capacity of the secondary storage 62, size of the logical volumes 10, position information of a data, writing time information and state information, in regard to the secondary storage 62.

Further, the host server 14 is an external device of the storage subsystem 4 which is the storage device, and, for example, is constituted by a computer. This host server 14 is used for the writing-in and reading-out of a data to the primary storage 61. Further, a maintenance control part 16, for example, is constituted by a computer, and a point that the maintenance control part 16 constitutes an interface performing maintenance, setting and so on of the storage subsystem 4 is similar to the first embodiment.

Furthermore, according to a constitution like this, since a data is temporarily stored in the primary storage 61, the primary storage 61 functions as a data buffer of the secondary storage 62. The storage server 8 executes the processing of data storage to the primary storage 61, the formation of a logical volume of the secondary storage 62, the storage processing of a data, and soon. Therefore, even in case in which the secondary storage 62 is constituted by the recordable storage medium, it is possible to perform the processing corresponding to a lapse of time relative to its reading-out and writing-in, and the efficiency of data storage processing may be improved.

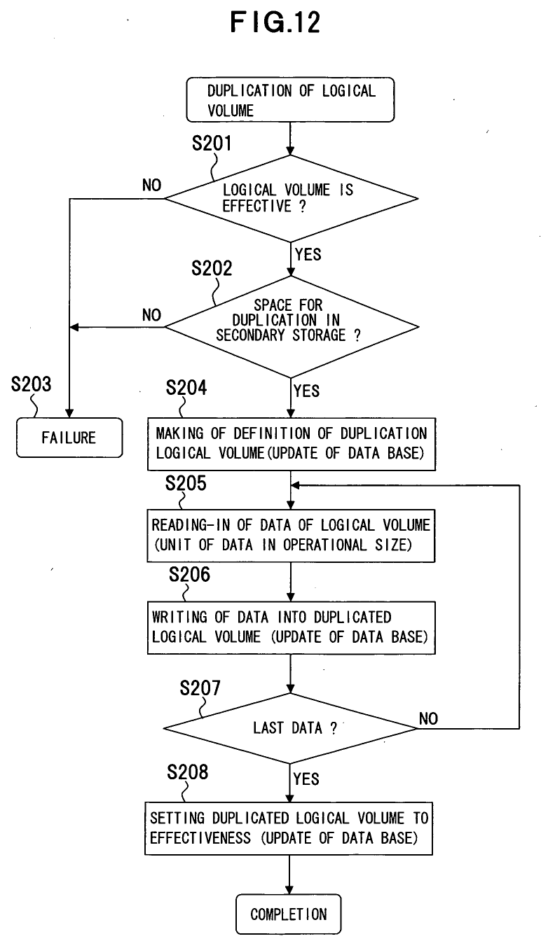

Next, the duplication processing of a logical volume according to the second embodiment of the present invention is explained by referring to FIG. 12. FIG. 12 is a flow diagram showing the processing procedure of a data processing method and a data processing program of the duplication processing of a logical volume.

This duplication processing is processing based on a duplication instruction of a logical volume from the maintenance control part 16, and, as the logical volumes 10 which are a duplicated object, for example, the processing concerning the logical volumes 101 is executed.

If the storage server 8 (FIG. 10) receives the duplication processing of the logical volume 101 from the maintenance control part 16, whether or not that logical volume 101 is effective is decided (a step S201). As described previously in the first embodiment, for this decision, the management information which is stored in the database 12 is referenced. To put it concretely, state information concerning the logical volume 101 which is stored in the logical volume status 41 of the logical volume management table 34 (FIG. 7) is referenced. In case in which this logical volume 101 is effective, whether or not there is a space able to make out the duplication of a logical volume in the secondary storage 62 is decided (a step S202). As described previously in the first embodiment, for this decision, the management information which is stored in the data base 12 is referenced, and whether or not the space able to make out the duplication of the logical volume 101 exists in the secondary storage 62 is decided by comparing the size of the logical volume 101, which is duplicated, with a space capacity in the storage mediums 71 through 7N which constitute the second storage 62. The size of the logical volume 101 is the information which is stored in the logical volume size 40 of the logical volume management table 34 (FIG. 7). And, in case in which the logical volume 101 is not effective (the step S201), or in case in which there is no space in the second storage 62 (the step S202) it is impossible to perform the duplication of the logical volume 101 (a step S203).

On the other hand, in case in which the space necessary for the duplication exists in the secondary storage 62, the duplicated logical volume 102 is defined. Along with this, the management information of the data base 12 is updated (a step S204), and a data of the logical volume 101 is read in (a step S205). In this case, as described previously, the reading-in of the data is performed with the unit of a data in an optional size.

After this reading-in of data, the writing-in of the data to the duplicated logical volume 102 and an update of the management information of the data base 12 are performed (a step S206). This writing-in of data is continued until all data are completed (the step S205—the step S206—a step S207). In case in which the last data comes from the logical volume 101, the duplicated logical volume 102 is set to effectiveness, the management information of the data base 12 is updated in regard to the data concerning that setting of effectiveness (a step S208), and the duplication processing is completed.

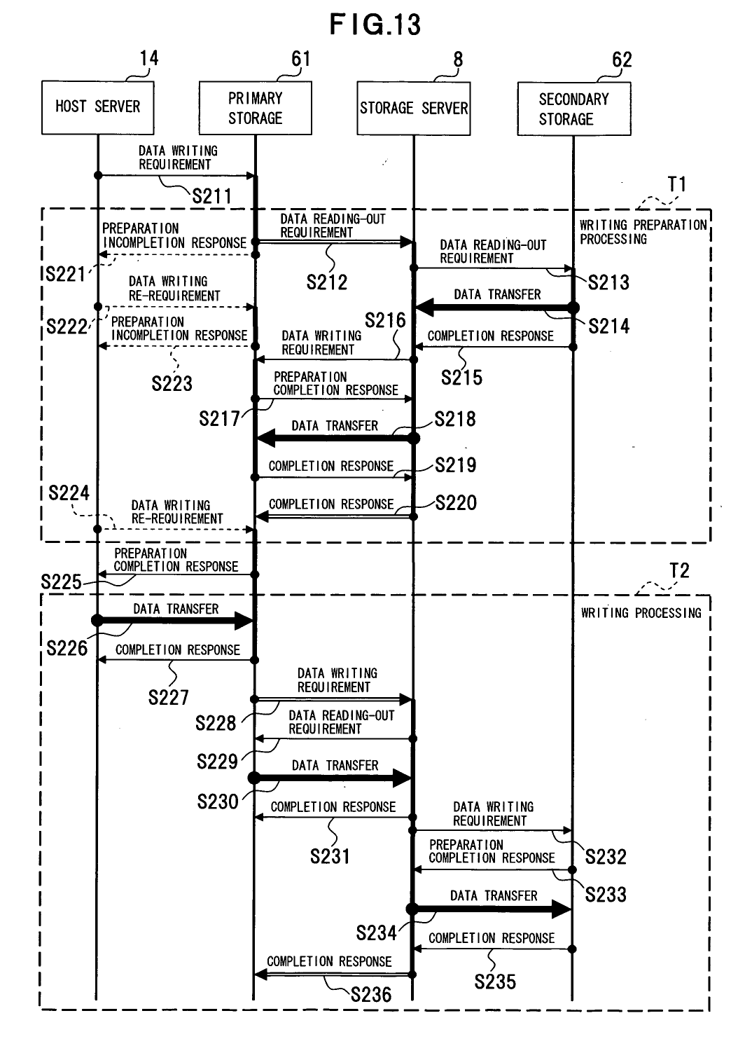

Next, a data processing method of the data processing system is explained by referring to FIG. 13. FIG. 13 is a drawing showing the processing sequence of a data processing method and a data processing program corresponding to a data writing requirement of the host server, according to the embodiment of the present invention.

This processing sequence is the processing of the storage subsystem 4 corresponding to the host server 14, and shows the data processing of the host server 14, the primary storage 61, the secondary storage 62 and the storage server 8.

A data writing requirement is generated from the host server 14 (a step S211), and, if the storage subsystem 4 receives this data writing requirement, writing preparation processing T1 is executed in the storage subsystem 4. In this case, the writing preparation processing T1 is the processing for the purpose of bringing a data from the secondary storage 62 in case in which the data of a logical volume corresponding to the writing requirement does not exist on the primary storage 61. Therefore, a data reading-out requirement is issued from the primary storage 61 to the storage server 8 with the data writing requirement as a trigger (a step S212), and, in response to this, a data reading-out requirement is given from the storage server 8 to the secondary storage 62 (a step S213.). In the secondary storage 62, a data transfer corresponding to the data reading-out requirement is performed (a step S214), and a completion response is issued with a completion thereof (a step S215).

The storage server 8 receiving the completion response of this data transfer performs a data writing requirement to the primary storage 61 (a step S216), receives a preparation completion response from the primary storage 61 (a step S217), and performs a data transfer (a step S218). As a result of this, if a completion response (a step S219) is given from the primary storage 61, the storage server 8 performs a completion response to the primary storage 61 (a step S220).

By the way, in the middle of preparation processing like this, since comparatively long time is needed in the secondary storage 62 until the data transfer from the reading-out requirement of the data, a preparation incompletion response is performed from the primary storage 61 to the host server 14 (a step S221), and the primary storage 61 receives a data writing re-requirement from the host server 14 (a step S222). Further, in case in which there is no data transfer from the secondary storage 62, the preparation incompletion response (a step S223) is performed, and the data writing requirement is issued again (a step S224). By this, it is possible to avoid inconvenience due to an indefinite lapse of time in the giving and receiving of data with the host server 14.

The above-mentioned preparation processing is the preparation of data writing corresponding to the writing requirement of a data, and, in case in which that preparation is executed in advance, this processing becomes unnecessary.

Then, a completion response of writing preparation is issued from the primary storage 61 (a step S225), and the processing shifts to writing processing T2. In this writing processing T2, a data transfer is performed from the host server 14 (a step S226), and a completion response is issued from the primary storage 61 receiving the data transfer (a step S227). A data writing requirement is issued from the primary storage 61 to the storage server 8 (a step S228), and a data reading-out requirement is issued from the storage server 8 to the primary storage 61 (a step S229). By this, a data transfer is performed from the primary storage 61 to the storage server 8 (a step S230), and a completion response thereof is issued from the storage server 8 to the primary storage 61 (a step S231). Further, if a data writing requirement is given from the storage server 8 to the secondary storage 62 (a step S232), and if a preparation completion response is issued from the secondary storage 62 to the storage server 8 (a step S233), a data transfer is performed from the storage server 8 (a step S234). Then, a completion response is issued from the secondary storage 62 to the storage server 8 (a step S235), and a completion response is issued from the storage server 8 to the primary storage 61 (a step S236). By performing such processing, the data writing of the secondary storage 62 is completed correspondingly to the data writing requirement from the host server 14. By such data writing, it is possible to perform the processing of the making of duplication of a logical volume, the copy of a data, and so on.

Next, by extracting technical matters from the embodiments of the storage device, the data processing method thereof, the data processing program thereof, the data processing system and soon, which are described above, the technical significance of these, the modified examples of these, the technical expanded matters of these, and so on, are enumerated in the following.

(1) As described previously, the data base 12 may also be constituted as a data base part by an internal disk of the storage server 8 which constitutes a hierarchy control server of a storage device, or it may also be constituted by using a part of an area in the storage subsystem 4. That is, the data base 12 may also be formed on the storage server 8, or may also be constituted separately from the storage server 8.

(2) For a computer which constitutes the maintenance control part 16, a host computer may also be used, or a computer separately from the host computer may also be used.

(3) The single storage 6 is provided in the first embodiment, and a plurality of storages which are the primary storage 61 and the secondary storage 62 is provided in the second embodiment. However, the storage subsystem may also be constituted so that three or more storages are provided.

(4) In connection with the first embodiment, the specification gives explanation of the composition of a logical volume (FIG. 3), the state image of a logical volume (FIG. 4), the data image concerning a data copy (FIG. 5), the formation of the management information of the data base 12 (FIG. 7), the duplication items in the data base (FIG. 8), and so on. However, these matters are similarly applied to also the processing of the making of duplication of a logical volume which is defined in the secondary storage 62, the copy of a data, and so on, in the second embodiment (FIGS. 10 to 13).

Although the best mode for carrying out the invention, the object, the configuration and the operation and effect have been described in detail above, the invention is not limited to such embodiment for carrying out the invention, and it is a matter of course that the invention can be variously changed or modified by a person skilled in the art on the basis of a gist and split of the invention as disclosed in claims and the detailed description of the invention, and such a change or modification, and various conjectured configurations, modified examples and so forth are included in the scope of the invention, and the description of the specification and drawings are not restrictively understood.

The entire disclosure of Japanese Patent Application No. 2004-382165 including specification, claims, drawings and summary are incorporated herein by reference in its entirety.

What is claimed is:

1. A storage device comprising:
a storage part that is constituted by a recordable storage medium and is defined by one or a plurality of logical volumes; and
a storage control part that controls operation of said storage part.

2. A storage device comprising:
a storage part, constituted by a recordable storage medium, in which one or a plurality of logical volumes is defined;
a data base part that stores management information of a data of said storage part; and
a storage control part that controls operation of said storage part by referring to said management information of said data base part.

3. A storage device comprising:
a first storage part that stores a data temporally;
a second storage part that is constituted by a recordable storage medium and is defined by one or a plurality of logical volumes; and
a storage control part that controls operation of either or both of said first storage part and said second storage part, and that makes said data transferred from said first storage part store in said second storage part.

4. A storage device comprising:
a first storage part that stores a data temporally;
a second storage part, constituted by a recordable storage medium, in which one or a plurality of logical volumes is defined, said second storage part storing said data transferred from said first storage part;
a data base part that stores management information of data of said first storage part and said second storage part; and
a storage control part that controls operation of either or both of said first storage part and said second storage part by referring to said management information of said data base part.

5. A storage device comprising:
a storage part, constituted by a recordable storage medium, in which one or a plurality of logical volumes is defined; and
a storage control part that makes out a duplicated logical volume in said storage part by receiving a duplication requirement of a logical volume from an outside, and that also makes a data of an existing logical volume store in said duplicated logical volume.

6. A storage device comprising:
a first storage part that stores a data temporally;
a second storage part, constituted by a recordable storage medium, in which one or a plurality of logical volumes is defined; and
a storage control part that makes out a duplicated logical volume in said storage part by receiving a duplication requirement of a logical volume from an outside, and that also writes a data of an existing logical volume in said duplicated logical volume through an intermediary of said first storage part.

7. A data processing method of a storage device which uses a recordable storage medium, comprising:
processing that defines one or a plurality of logical volumes in a storage part which is constituted by the recordable storage medium; and
processing that controls operation of said storage part.

8. A data processing method of a storage device which uses a recordable storage medium, comprising:
processing that defines one or a plurality of logical volumes in a storage part constituted by the recordable storage medium;
processing that stores management information of a data of said storage part in a data base part; and
processing that controls operation of said storage part by referring to said management information of said data base part.

9. A data processing method of a storage device which uses a recordable storage medium, comprising:
processing that stores a data in a first storage part temporally;
processing that defines one or a plurality of logical volumes in a second storage part constituted by the recordable storage medium; and
processing that controls operation of either or both of said first storage part and said second storage part, and that makes said data transferred from said first storage part store in said second storage part.

10. A data processing method of a storage device which uses a recordable storage medium, comprising:
processing that stores a data in a first storage part temporally;
processing that defines one or a plurality of logical volumes in a second storage part constituted by the recordable storage medium;
processing that stores management information of data of said first storage part or said second storage part in a data base part;
processing that controls operation of either or both of said first storage part and said second storage part by referring to said management information of said data base part; and
processing that makes said data transferred from said first storage part store in said second storage part.

11. A data processing method of a storage device which uses a recordable storage medium, comprising:
processing that defines one or a plurality of logical volumes in a storage part constituted by the recordable storage medium;
processing that makes out a duplicated logical volume in said storage part by receiving a duplication requirement of a logical volume from an outside; and
processing that makes a data of an existing logical volume store in said duplicated logical volume.

12. A data processing method of a storage device which uses a recordable storage medium, comprising:
processing that stores a data in a first storage part temporally;
processing that defines one or a plurality of logical volumes in a second storage part constituted by the recordable storage medium;
processing that makes out a duplicated logical volume in said storage part by receiving a duplication requirement of a logical volume from an outside; and
processing that writes a data of an existing logical volume in said duplicated logical volume through an intermediary of said first storage part.

13. A data processing program of a storage device, which is executed by a computer, comprising:
a step that defines one or a plurality of logical volumes in a storage part constituted by a recordable storage medium; and
a step that controls operation of said storage part.

14. A data processing program of a storage device, which is executed by a computer, comprising:
a step that defines one or a plurality of logical volumes in a storage part constituted by the recordable storage medium;
a step that makes management information of a data of said storage part store in a data base part; and
a step that controls operation of said storage part by referring to said management information of said data base part.

15. A data processing program of a storage device, which is executed by a computer, comprising:
a step that makes a data store in a first storage part temporally;
a step that defines one or a plurality of logical volumes in a second storage part constituted by the recordable storage medium; and
a step that controls operation of either or both of said first storage part and said second storage part, and that makes said data transferred from said first storage part store in said second storage part.

16. A data processing program of a storage device, which is executed by a computer, comprising:
a step that makes a data store in a first storage part temporally;
a step that defines one or a plurality of logical volumes in a second storage part constituted by the recordable storage medium;
a step that makes management information of data of said first storage part or said second storage part store in a data base;
a step that controls operation of either or both of said first storage part and said second storage part by referring to said management information of said data base part; and
a step that makes said data transferred from said first storage part store in said second storage part.

17. A data processing program of a storage device, which is executed by a computer, comprising:
a step that defines one or a plurality of logical volumes in a storage part constituted by the recordable storage medium;
a step that makes out a duplicated logical volume in said storage part by receiving a duplication requirement of a logical volume from an outside; and
a step that makes a data of an existing logical volume store in said duplicated logical volume.

18. A data processing program of a storage device, which is executed by a computer, comprising:
a step that makes a data store in a first storage part temporally;
a step that defines one or a plurality of logical volumes in a second storage part constituted by the recordable storage medium;
a step that makes out a duplicated logical volume in said storage part by receiving a duplication requirement of a logical volume from an outside; and
a step that writes a data of an existing logical volume in said duplicated logical volume through an intermediary of said first storage part.

19. A data processing system which has a storage device using a recordable storage medium, comprising:
said storage device having
a storage part, constituted by the recordable storage medium, in which one or a plurality of logical volumes is defined; and
a storage control part that controls operation of said storage part.

20. A data processing system which has a storage device using a recordable storage medium, comprising:
said storage device having
a storage part, constituted by the recordable storage medium, in which one or a plurality of logical volumes is defined;
a data base part that stores management information of a data of said storage part; and
a storage control part that controls operation of said storage part by referring to said management information of said data base part.

21. A data processing system which has a storage device using a recordable storage medium, comprising:
said storage device having
a first storage part that stores a data temporally;
a second storage part that is constituted by the recordable storage medium and is defined by one or a plurality of logical volumes; and
a storage control part that controls operation of either or both of said first storage part and said second storage part, and that makes said data transferred from said first storage part store in said second storage part.

22. A data processing system which has a storage device using a recordable storage medium, comprising:
said storage device having
a first storage part that stores a data temporally;
a second storage part, constituted by the recordable storage medium, in which one or a plurality of logical volumes is defined, said second storage part storing said data transferred from said first storage part;
a data base part that stores management information of data of said first storage part and said second storage part; and
a storage control part that controls operation of either or both of said first storage part and said second storage part by referring to said management information of said data base part.

23. A data processing system which has a storage device using a recordable storage medium, comprising:
said storage device having
a storage part, constituted by the recordable storage medium, in which one or a plurality of logical volumes is defined; and
a storage control part that makes out a duplicated logical volume in said storage part by receiving a duplication requirement of a logical volume from an outside, and that also makes a data of an existing logical volume store in said duplicated logical volume.

24. A data processing system which has a storage device using a recordable storage medium, comprising:
said storage device having
a first storage part that stores a data temporally;
a second storage part, constituted by the recordable storage medium, in which one or a plurality of logical volumes is defined; and
a storage control part that makes out a duplicated logical volume in said storage part by receiving a duplication requirement of a logical volume from an outside, and that also writes a data of an existing logical volume in said duplicated logical volume through an intermediary of said first storage part.

25. A storage device comprising:
a storage part which is constituted by a recordable storage medium; and
a storage control unit which is connected to said storage part and controls operation of said storage part, wherein
said storage part is defined by one or a plurality of logical volumes that is constituted by one or a plurality of logical blocks,
said storage control unit has a data base part in which a logical volume management table provided at each logical volume is defined, and in which a logical block management table provided at each logical block constituting said logical volume is defined,
in said logical volume management table, a logical block management table pointer that indicates said logical block management table of each logical block is set, and
in said logical block management table, position information of a data corresponding to a concerned logical block and a pre-logical-block management table pointer that is made to correspond to a logical block management table concerning a pre-data before an update of said data are set.

26. A storage device comprising:
a storage part which is constituted by a recordable storage medium; and
a storage control unit which is connected to said storage part and controls operation of said storage part, wherein
said storage part is defined by one or a plurality of logical volumes that is constituted by one or a plurality of logical blocks,
a data base part is connected to said storage control unit,
in said data base part, a logical volume management table provided at each logical volume is defined, and a logical block management table provided at each logical block constituting said logical volume is also defined,
in said logical volume management table, a logical block management table pointer that indicates said logical block management table of each logical block is set, and
in said logical block management table, position information of a data corresponding to a concerned logical block and a pre-logical-block management table pointer that is made to correspond to a logical block management table concerning a pre-data before an update of said data are set.

27. A data base comprising:
said data base being connected to a storage control unit controlling operation of a storage part which is constituted by a recordable storage medium and is defined by one or a plurality of logical volumes constituted by one or a plurality of logical blocks, wherein
a logical volume management table provided at each logical volume is defined, and a logical block management table provided at each logical block constituting said logical volume is also defined,
in said logical volume management table, a logical block management table pointer that indicates said logical block management table of each logical block is set, and
in said logical block management table, position information of a data corresponding to a concerned logical block and a pre-logical-block management table pointer that is made to correspond to a logical block management table concerning a pre-data before an update of said data are set.

28. A storage control unit comprising:
said storage control unit being connected to a storage part, which is constituted by a recordable storage medium and is defined by one or a plurality of logical volumes constituted by one or a plurality of logical blocks, and controlling operation of said storage part, wherein
said storage control unit has a data base part in which a logical volume management table provided at each logical volume of said storage part is defined, and in which a logical block management table provided at each logical block constituting said logical volume is also defined,
in said logical volume management table, a logical block management table pointer that indicates said logical block management table of each logical block is set, and
in said logical block management table, position information of a data corresponding to a concerned logical block and a pre-logical-block management table pointer that is made to correspond to a logical block management table concerning a pre-data before an update of said data are set.

29. A storage control unit comprising:
said storage control unit being connected to a storage part, which is constituted by a recordable storage medium and is defined by one or a plurality of logical volumes constituted by one or a plurality of logical blocks, and controlling operation of said storage part by using management information stored in a data base part, wherein
in said data base part, a logical volume management table provided at each logical volume of said storage part is defined, and a logical block management table provided at each logical block constituting said logical volume is also defined,
in said logical volume management table, a logical block management table pointer that indicates said logical block management table of each logical block is set, and
in said logical block management table, position information of a data corresponding to a concerned logical block and a pre-logical-block management table pointer that is made to correspond to a logical block management table concerning a pre-data before an update of said data are set.

30. A storage medium comprising the data processing program of claim 13, 14, 15, 16, 17 or 18 that is stored in said storage medium.
